(19) United States
(12) Patent Application Publication
(10) Pub. No.: US 2009/0024313 A1
(43) Pub. Date: Jan. 22, 2009

(54) Method For Operating A Mobile Navigation Device

(76) Inventor: Bernd Hahn, Uffenheim (DE)

Correspondence Address: QUARLES & BRADY LLP, 411 E. WISCONSIN AVENUE, SUITE 2040, MILWAUKEE, WI, 53202-4497, US

(21) Appl. No.: 12/115,752

(22) Filed: May 6, 2008

(30) Foreign Application Priority Data
Jul. 17, 2007 (DE) 10 2007 033 597.2
Mar. 11, 2008 (EP) 08 004 449.8

(51) Int. Cl. G01C 21/36

(52) U.S. Cl. 701/200

(57) ABSTRACT

A method for operating a mobile navigation device in a vehicle. The vehicle is equipped with a radio device and wherein the navigation device encompasses at least one device for generating maneuvering instructions and a transmitter device for generating radio signals and wherein signals can be transmitted by the navigation device to the receiving part of the radio device by means of the transmitter device. The method includes the following method steps: a) computing a maneuvering display including a maneuvering instruction, which is to be displayed graphically; b) encoding the maneuvering display as a radio signal; and c) transmitting the maneuvering display, which is encoded as a radio signal, by the transmitter device of the navigation device, for transmitting the maneuvering display to the radio device.

### CROSS-REFERENCE TO RELATED APPLICATION

This application claims the priority benefit of German Patent Application No. 10 2007 033 597.2 filed on Jul. 17, 2007 and European Patent Application No. 08 004 449.8 filed on Mar. 11, 2008, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention relates to a method for operating a mobile navigation device in a vehicle equipped with a radio device, wherein the navigation device encompasses at least one device for generating maneuvering instructions and a transmitter device for generating radio signals and wherein signals can be transmitted by the navigation device to the receiving part of the radio device by means of the transmitter device.

### SUMMARY OF THE INVENTION

A navigation device, which supports the driver of a vehicle in locating a suitable route for approaching a destination is known from DE 20 2006 011 878 U1. The navigation device thereby also generates in particular acoustic navigational instructions. These navigational instructions are converted into radio signals by means of a transmitter device, which is integrated in the navigation device and are transmitted on a very high frequency with a relatively small transmission power. The very high frequency radio signals generated by the transmission device of the navigation device are received by means of the radio antenna of the vehicle and are emitted so as to be capable of being acoustically perceived in the vehicle using the radio device, which is installed in the vehicle. In so doing, the acoustic navigational instructions can be output with a very high sound quality using the radio device installed in the vehicle, in particular using the loudspeaker system.

The method known from the state of the art has the disadvantage that it is only possible to transmit acoustic maneuvering instructions and to output them by using the installed equipment in the vehicle. For this reason, a correspondingly suitable display device, for example a LCD display, is mandatory in the known navigation devices so as to be able to display maneuvering instructions, which are to be displayed graphically, to the user. Furthermore, the display device of a navigation device is oftentimes not optimal, because the navigation device cannot be positioned in the optimal position in the field of vision of the driver. This is the case in particular with retrofit devices.

It is thus the object of the present invention to propose a new method for operating a mobile navigation device, with which the output possibilities of maneuvering instructions in the vehicle are broadened.

This object is achieved in one embodiment of the invention by computing a maneuvering display including a maneuvering instruction, which is to be displayed graphically; b) encoding the maneuvering display as a radio signal; and c) transmitting the maneuvering display, which is encoded as a radio signal, by the transmitter device of the navigation device, for transmitting the maneuvering display to the radio device.

The method as claimed in the invention is based on the basic assumption that displays of maneuvering instructions, which are to be displayed graphically and which shall be referred to below as maneuvering displays, are computed. Generally, these maneuvering displays provide the driver with information relating to the driving maneuvers, which he is to perform so as to follow the route which was computed by the navigation device.

To be able to display these maneuvering displays by using display devices, which are already provided in the vehicle, for example the display of a radio device installed in the vehicle, the maneuvering display in the navigation device is encoded as a radio signal. Subsequently, the transmission device of the navigation device transmits this maneuvering display, which is encoded as a radio signal, for example on the very high frequency so that the receiving part of the radio device in the vehicle can receive this encoded maneuvering display and subsequently display it on a display device, which is already provided in the vehicle.

To be able to display the maneuvering displays, which are encoded as radio signals, in the vehicle, the maneuvering displays must be decoded. So as not to have to make device requirements for this decoding, which are too high, and/or so as to enable a real time display of the maneuvering display in the vehicle, it is thus particularly advantageous if the graphic display of the maneuvering displays is kept to be particularly simple for the purpose of allowing for the encoding and the decoding, respectively, in a simple manner and in a relatively short period. By using letters, digits and special characters, the maneuvering displays can be encoded as text messages in a particularly simple and effective manner.

As a basic principle, it is optional according to which rules the encoding and decoding, respectively, of the maneuvering display takes place. It is particularly advantageous if the maneuvering display is encoded according to the Radio Data System(RDS) standard. This is advantageous in particular because most of the radio device types known from the state of the art are able to decode the RDS protocol so that the maneuvering displays transmitted by the transmission device of the navigation device can be decoded in the radio device according to the RDS standard without additional device requirements. It is thereby particularly advantageous if the maneuvering display is encoded as a PI service (Program Identification) according to the RDS standard. Typically, the program identifiers of the different radio programs are transmitted via the PI service of the RDS transmission protocol. Due to the fact, however, that these program identifiers ultimately consist of characters, that is, letters, digits and special characters, it is easily possible to also encode a maneuvering display, which is to be displayed graphically, in the PI service of the RDS transmission protocol.

As a basic principle, the components of the graphic maneuvering display, which is transmitted to the radio device as an encoded radio signal, are optional. To allow for simple embodiments, the maneuvering display can preferably include arrow symbols for displaying the turning direction of the next maneuver.

Furthermore, it is particularly advantageous if the maneuvering display includes text information for displaying the distance to the next maneuver.

In the event of the specification of distances to the next maneuver, it is particularly advantageous if the corresponding display is updated dynamically, while the vehicle approaches the maneuver. In other words, this means that the current distance is specified constantly so that the driver can be informed of the current distance in real time by means of the corresponding display.

Furthermore, the maneuvering display can also include data relating to the description of the destination street of the next maneuver. This can take place, for example, by specifying the street name or a street number, for example the number of a freeway or the number of a main road.

In addition to the data relating to the description of the maneuvering instruction, the maneuvering display can also include additional data. These data can be, for example, the description of speed limits and/or traffic information. These additional data are then also encoded to the radio signal and the transmission device of the navigation device transmits them to the receiving part of the radio device together with the encoded maneuvering display. In so doing, these additional data can then be displayed on the display device in the vehicle.

According to a further alternative, the maneuvering display can also include data for the description of markers or direction signs, which are to be expected along a route, which is computed by the navigation device. The corresponding information relating to the direction signs along the roads of a road network, for example, are typically stored as direction sign data sets in the databases relating to the description of the road network and can be selected individually.

Provided that the maneuvering display includes different information contents, these different components of the maneuvering display can be transmitted and displayed in a chronologically offset manner. In addition to the specification of the distance to the next maneuver, it is thus also possible, for example, to display a speed limit in the current road section at intermittent intervals. As an alternative, it is also possible for different components of the maneuvering display to be labeled with different priorities, wherein the components having a higher priority are then always displayed first and the components having a low priority are only displayed later.

In addition to the functionality for navigating, the navigation device can also encompass additional functionalities. A media player, for example a CD player, a DVD player, an MP3 player and/or a DVB player can be integrated into the navigation device. The corresponding output signals of these players, which generally are acoustic contents, can also be transmitted by the navigation device to the radio device via a radio signal. In addition to the encoded maneuvering display, the radio signal then also comprises the acoustic contents.

The functionality of a cellular phone and the functionality of a second radio device can also be integrated into the navigation device according to the functionality of a media player. The corresponding acoustic signals of these devices (cellular phone, radio device) are then also modulated up to the radio signal of the transmission device of the navigation device and are transmitted to the radio device in the vehicle.

As a basic principle, it is optional in which way the display of the maneuvering display takes, place in the vehicle. After the receipt of the maneuvering display in the radio device, this can be displayed on the display of the radio device, for example, in a particularly simple manner. According to a preferred embodiment, provision is made for the radio device to transmit the decoded maneuvering display to an external functional unit in the vehicle, for example a multi-function display in the dashboard of the vehicle. The maneuvering display can then be displayed by means of a display device in this external functional unit, whereby an optimal positioning of the maneuvering display in the field of vision of the user can be made possible.

It goes without saying that the display of the navigational instruction on a display device of the vehicle can also be supplemented by the display of maneuvering instructions on a display device of the navigation device itself. As a result, two displays are then provided to the driver. The different displays can be matched accordingly to the respective use and can comprise different display components.

In particular, the simultaneous output of graphic maneuvering displays and acoustic maneuvering displays is also advantageous because graphic maneuvering displays can be displayed for a longer period without disrupting the driver. It is thus particularly advantageous if maneuvering displays are transmitted and displayed longer than the assigned acoustic maneuvering instructions. If, for example, the driver is informed that the next maneuver must take place in 400 meters, this information can be displayed continuously and updated dynamically for a longer period by means of the graphic maneuvering display.

If the transmission of the encoded maneuvering display takes place for a longer period, the radio transmission of the maneuvering display should again be terminated after a predetermined period and/or after a predetermined distance has been covered. This ensures that components of the maneuvering instruction, which are already no longer up to date, are no longer displayed. It is possible in this case that no message or a standard message is displayed or a display, which can be configured by the user in the navigation device and which represents, e.g., the distance and/or time to the destination and to the next maneuver, respectively, and which updates automatically, is displayed.

It is also advantageous if the user is able to activate and deactivate the described function in his navigation device, since a suitable display is not always available, depending on the vehicle equipment, and processing power can thus be cut down in the navigation device.

An embodiment of the invention is illustrated schematically in the drawings and will be defined below in an exemplary manner.

### BRIEF DESCRIPTION OF THE DRAWINGS

FIG. 1 shows the functional design of a mobile navigation device in cooperation with a radio device in a vehicle using the method as claimed in the invention,

FIGS. 2a to 2d show different examples of maneuvering displays and other displays, which have been encoded as RDS text messages and which have been transmitted via radio signal.

### DETAILED DESCRIPTION OF THE EXAMPLE EMBODIMENTS

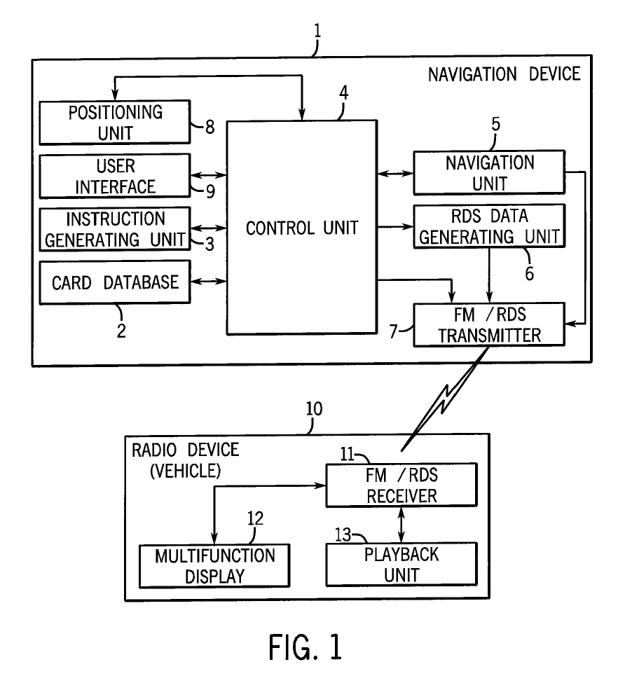

FIG. 1 represents the functional design of a navigation device 1 in cooperation with a radio device 10 installed in a vehicle during the operation of the method as claimed in the invention. The navigation device thereby comprises the functionality of a card database 9, of an instruction generating unit 3, of a central control unit 4, of a navigation unit 5, of an RDS data generating unit 6, of an FM/RDS transmitter 7 and of a positioning unit 8. The radio device 10 comprises the functionality of an FM/RDS receiver 11, of a playback unit 13 for the playback of acoustic signals and of a multifunction display 12 for displaying graphic maneuvering displays.

In response to carrying out the method as claimed in the invention, a maneuvering instruction is generated in the instruction generating unit 3 and is forwarded to the control unit 4. In the control unit 4, a graphic maneuvering display is generated from the maneuvering instruction and is forwarded to the RDS data generating unit 6. In the RDS data generating unit 6, the graphic maneuvering display is encoded into a radio signal according to the RDS transmission protocol and is subsequently forwarded to the FM/RDS transmitter 7. The FM/RDS transmitter 7 transmits the encoded maneuvering display very high frequency radio signals to the FM/RDS receiver 11 of the radio device 10 in the vehicle. There, the RDS signal is decoded and the maneuvering display, which is to be displayed graphically, is forwarded to the multifunction display 12. There, the maneuvering display is then displayed to the user in the vehicle.

Parallel thereto, acoustic maneuvering instructions can also be transmitted by the transmitter 7 to the receiver 11 via radio signal and can then be played back by the playback unit 13 so as to be acoustically audible in the vehicle. During the operation of the navigation device 1 in cooperation with the radio device 10, the following maneuvering instruction is then possible, for example.

The driver enters the freeway and hears the following acoustic driving instruction: “Follow the road for 146 km”. At the same time, the following text is displayed on the display of the car radio or on the multifunction display of the instrument cluster in the dashboard: “↑146 km”. In the further course of the drive, this graphic information is constantly updated dynamically and the current distance mileage is displayed.

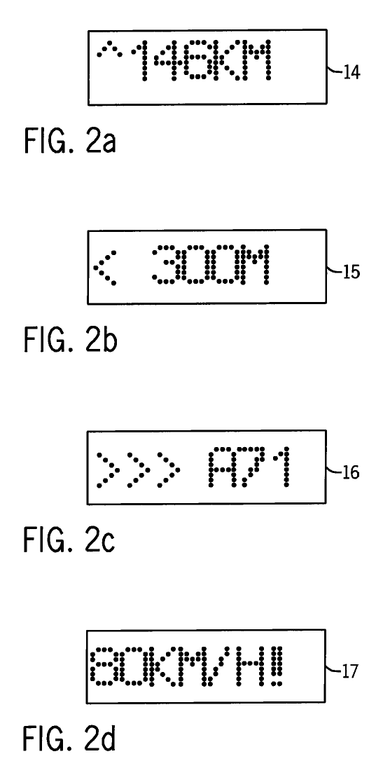

FIG. 2a shows the display on the display 12 of the radio device 10 according to this maneuvering display 14. The maneuvering display 14 is designed as a simple text message and can, in this respect, be transmitted as a PI service of the RDS transmission protocol without any problems.

FIGS. 2b to 2d show further examples 15, 16 and 17 of maneuvering displays, which are encoded as RDS signals. The maneuvering display 15 according to FIG. 2b can be accompanied by the acoustic maneuvering instruction, for example: “Turn left in 300 meters”. Combinations of information, such as distance and destination street, are also possible, e.g. “<300 m B8”.

The maneuvering display 16 in FIG. 2c can be accompanied by the acoustic driving instruction: “Turn right onto A71”.

As is illustrated in FIG. 2d, in addition to the data of the actual maneuver further data can also be transmitted and can be displayed on the display as an additional display. For example, information relating to speed limits which are available in the navigation device can be encoded as an RDS signal and can be transmitted to the radio device by the navigation device. FIG. 2d shows, for example, the maneuvering display 17, which signals a speed limit of 80 km/h. This graphic display could be accompanied, for example, by the acoustic announcement: “Attention! Speed limit 80 km/h”.

Upon arrival at the desired destination, the maneuvering display “destination” could be output on the graphic display, which can be accompanied by the maneuvering announcement “You have reached your destination”. If “You have reached your destination, it is located on the right-hand side” is output as an announcement, the output can appear as follows: “destination>”.

1. A method for operating a mobile navigation device in a vehicle, wherein the vehicle is equipped with a first radio device and wherein the navigation device encompasses at least one device for generating maneuvering instructions and a transmitter device for generating radio signals and wherein signals can be transmitted by the navigation device to a receiving part of the radio device by means of the transmitter device, said method comprising the following method steps:
a) computing a maneuvering display including a maneuvering instruction, which is to be displayed graphically;
b) encoding the maneuvering display as a radio signal; and
c) transmitting the maneuvering display, which is encoded as a radio signal, by the transmitter device of the navigation device, for transmitting the maneuvering display to the radio device.

2. The method according to claim 1, in which the maneuvering display is encoded as a text message using letters, digits and special characters.

3. The method according to claim 1, in which the maneuvering display is encoded according to a Radio Data System (RDS) standard, in particular the maneuvering display is encoded as a Program Identification (PI) service according to the RDS standard.

4. The method according to claim 1, in which the maneuvering display includes arrow symbols for displaying a driving direction, in particular a turning direction of a next maneuver.

5. The method according to claim 1, in which the maneuvering display includes text information for displaying a distance to a next maneuver.

6. The method according to claim 5, in which the text information for displaying the distance to the next maneuver are updated dynamically.

7. The method according to claim 1, in which the maneuvering display includes data for describing a destination street of a next maneuver.

8. The method according to claim 1, in which the maneuvering display additionally includes data for describing speed limits and/or traffic information.

9. The method according to claim 1, in which the maneuvering display includes data for describing markers or direction signs, which are to be expected along a route which is computed by the navigation device.

10. The method according to claim 1, in which different components of the maneuvering display are transmitted and displayed in a chronologically offset manner.

11. The method according to claim 1, in which the navigation device comprises the functionality of a media player, in particular the functionality of a DVD player and/or the functionality of a CD player and/or the functionality of an MP3 player and/or the functionality of a Digital Video Broadcasting (DVB) player and in that media contents, which are to be output acoustically and/or optically, can be transmitted to the radio device by the navigation device as part of the radio signals.

12. The method according to claim 1, in which the navigation device comprises the functionality of a cellular phone and in that messages of the cellular phone, which are to be output acoustically, in particular dialog contents, which are to be output acoustically, can be transmitted to the radio device by the navigation device as part of the radio signals.

13. The method according to claim 1, in which the navigation device comprises the functionality of a second radio device and in that radio program contents, which are to be output acoustically, can be transmitted to the first radio device in the vehicle by the navigation device as part of the radio signals.

14. The method according to claim 1, in which the first radio device in the vehicle is connected to an external functional unit in the vehicle, in particular to a multifunction display in a dashboard of the vehicle, wherein the maneuvering display transmitted to the first radio device can be displayed on a display device of the external functional unit.

15. The method according to claim 1, in which the maneuvering display is transmitted and displayed for a longer period than an assigned acoustic maneuvering instruction.

16. The method according to claim 1, in which transmission of the maneuvering display is ended after a predetermined period and/or after a predetermined distance has been covered.
